(19) United States
(12) Patent Application Publication
(10) Pub. No.: US 2026/0275999 A1
(43) Pub. Date: Sep. 17, 2026

(54) COLD SPRAY REINFORCED IMPELLER SHROUD

(71) Applicant: NUOVO PIGNONE TECNOLOGIE – S.R.L., Florence (IT)

(72) Inventors: Riccardo Brogelli, Florence (IT); Michelangelo Bellacci, Florence (IT)

(21) Appl. No.: 19/696,221

(22) Filed: Jun. 2, 2026

Related U.S. Application Data
(63) Continuation of application No. 17/103,535, filed on Nov. 24, 2020.

(30) Foreign Application Priority Data
Nov. 24, 2020 (EP) 20209619.4

(51) Int. Cl. F04D 29/28; C23C 24/04; F01D 5/02

(52) U.S. Cl. CPC F04D 29/284; C23C 24/04; F01D 5/02; F05D 2230/31; F05D 2300/174

(57) ABSTRACT

A shrouded impeller for centrifugal compressors, and methods for manufacturing shrouded impellers for centrifugal compressors are provided. In one embodiment, the method includes manufacturing an impeller base, then depositing by cold spraying at least one layer of metallic material on the surface of the frontal part of the impeller corresponding to the shroud of the impeller and machining the impeller to complete and finish the structure thereof. The at least one layer deposited by cold spraying may include grooves adapted to optimize the dynamic behavior of the impeller by modifying and tuning the local natural frequencies.

### CROSS-REFERENCE TO RELATED APPLICATIONS

This application is a continuation application of U.S. Ser. No. 17/103,535, filed on Nov. 24, 2020, and entitled “COLD SPRAY REINFORCED IMPELLER SHROUD,” which claims the benefit of priority to European Patent Application No. 20209619.4, filed on Nov. 24, 2020. The content of these applications is incorporated herein by reference in its entirety

### BACKGROUND

The subject matter of the present disclosure relates to a shrouded impeller and to a method for manufacturing shrouded impellers, in particular for centrifugal compressors, characterized by a reduced mechanical stress caused by the applied centrifugal forces during operation, and adapted to perform at higher peripheral speed with respect to the state-of-the-art technology, without incurring in structural problems.

Radial flow turbo machinery devices are adapted to convert shaft power to kinetic energy (and vice versa) by accelerating (or decelerating) a fluid in a revolving device called impeller. When used as power-absorbing machines, impellers are commonly used to raise the pressure of a fluid or induce a fluid flow in a piping system.

The impeller is the device, within the centrifugal compressors and the turbo machinery in general, that, rotating, exchanges energy with the fluid. In its simplest implementation the impeller comprises a plurality of blades fitted onto a hub plate. The shape and the geometry of impeller blades can be of many different types depending on the use, the rating, the performance of the turbo machinery.

A compressor, for instance, is a machine adapted to accelerate the particles of a compressible fluid, e.g., a gas, through the use of mechanical energy to increase the pressure of that compressible fluid. Compressors are used in a number of different applications, including gas turbines engines. Among the various types of compressors are the centrifugal compressors, in which the mechanical energy operates on the gas input to the compressor by way of centrifugal acceleration which accelerates the gas particles, e.g., by rotating a centrifugal impeller through which the gas is passing. More generally, centrifugal compressors are part of a class of machinery generally referred to as “turbo machines” or “turbo rotating machines”.

Compressors, and centrifugal compressors in particular, can be fitted with a single impeller, i.e., a single stage configuration, or with a plurality of impellers in series, in which case they are frequently referred to as multistage compressors. Each of the stages of a centrifugal compressor typically includes an inlet conduit for gas to be accelerated, an impeller which is capable of providing energy to the gas and a diffuser which converts part of the kinetic energy of the gas leaving the impeller into pressure. In multistage centrifugal compressors, after the diffuser there will be a return channel that conducts the flow to the next impeller. Impellers can be shrouded or unshrouded.

Centrifugal Compressors may often employ unshrouded, or open, impellers to accelerate or apply energy to the process fluid, as the open impellers may often be relatively easier to manufacture and, typically, allow for higher peripheral speed with respect to shrouded, or closed, impellers. However, the centrifugal compressors employing open impellers may exhibit decreased performance and/or efficiencies, for example due to the fact that a portion of the process fluid may flow or leak out of the open impellers through clearances defined between the blades and the statoric part of the compressor, thereby reducing the overall efficiency thereof. On the other hand, in order to limit the leakage between the impeller blades and the statoric part of the compressor, the clearance in between these components is kept very tight, thus limiting this kind of centrifugal compressors to applications where the relative movement between the impeller blades and the statoric parts of the compressor is not too high.

Thus, centrifugal compressors may often employ shrouded impellers with at least one seal between the statoric part and the shroud in order to reduce or eliminate the clearances between said statoric part and the impeller and allow larger relative displacements. However, shrouded impellers are not free from drawbacks. The outer periphery of both shrouded and unshrouded impellers can be distorted as a result of the centrifugal forces developing during operation due to the impeller high rotational speed. Since the shroud is a disk subject to larger displacements with respect to the hub and the blades are attached to both the shroud and the disk, shrouded impellers are subject to a much higher stress and typically allow for lower peripheral speed with respect to unshrouded impellers.

Typically shrouded impellers allow a better efficiency while they are more prone to suffer mechanical stress that limits the maximum allowable impeller peripheral speed and, consequently, the maximum head that can be provided to the processed fluid.

Impellers provided with shrouds made of carbon fiber are known in the art, however, carbon fiber material is fragile and subject to the attack of gasses. Moreover, coupling a shroud in carbon fiber to a steel impeller, comprising a hub and a number of blades, is extremely difficult due to the very different relative deformations of shroud and impeller at high peripheral speeds and due to the fact that carbon fiber doesn't do plastic deformation.

For the reasons explained above, impellers with shrouds made of carbon fiber are therefore rarely employed in extreme industrial applications such as Oil & Gas industrial applications.

A problem which is relevant in the state of the art is therefore how to provide shrouded impellers adapted to withstand the centrifugal forces at high peripheral speed, allowing levels of power density close to the power density levels of unshrouded impellers.

### SUMMARY

Embodiments of the present disclosure therefore relate to a shrouded impeller and to a method for manufacturing shrouded impellers, in particular for turbo machines.

The method described herein employs known techniques of additive manufacturing and, in particular, cold spray additive manufacturing to add one or more layers of appropriate materials on the impeller hub and/or on the impeller shroud. The cold spray process is a solid-state coating deposition technology that has recently established as an additive manufacturing process. In comparison with high-temperature additive manufacturing processes, cold spray additive manufacturing produces oxide-free deposits and has proved better in retaining the original properties of the raw material to process without damaging it during manufacturing.

Embodiments of the present disclosure further relates to impellers and impeller shrouds provided with added material deposited through cold spray additive manufacturing and adapted to reduce the stresses of the impeller subject to rotation with high peripheral speed.

The material deposited by cold spray additive manufacturing may comprise multiple layers, each one with a specific shape, material and/or characteristic, according to the needs. Preferred embodiments comprising one, two, three and four deposited layers are described and examples of metal base alloys to manufacture said layers are given. Embodiments comprising more than four deposited layers are within the scope of the present disclosure, as well.

Finally, various examples of deposited layers and geometry thereof are given. Each example embodies geometries adapted to optimize cohesion between layers and the performance of the impeller with respect to a wide range of impeller geometries, excitations, natural vibration frequencies and working temperatures.

In particular, the geometries of the described deposited layers are adapted to modify the local natural frequencies and can be tuned in order to avoid dangerous crossings between natural and exciting frequencies that can be harmful to the integrity of the impeller. Being the stiffness and the density of the employed material the key to determine the vibration frequency of an object, then employing, for the shroud according to the present disclosure, different materials of various thickness allows modifying the local stiffness and density of the shroud based on the thickness of the different materials the shroud is made of.

The illustrated shapes and geometries can be chosen to optimize the cohesion between the base material and the added material. The added material is preferably deposited in several areas delimited by a plurality of lines of no added material. The number of said lines can be made proportional to the number of the blades of the impeller.

### DRAWINGS

Aspects of the present invention will become more apparent from the following description of exemplary embodiments to be considered in conjunction with accompanying drawings wherein:

FIG. 1 shows a partial sectional view and a front view of the shroud of a preferred embodiment of the impeller according to the present disclosure. The surface of the shroud comprise a plurality of sectors separated from each other by straight grooves;

FIG. 2 shows a partial sectional view and a front view of the shroud of a preferred embodiment of the impeller according to the present disclosure. The surface of the shroud comprise a plurality of sectors separated from each other by curved grooves;

FIG. 3 shows a partial sectional view and a front view of the shroud of a preferred embodiment of the impeller according to the present disclosure. The surface of the shroud comprise a plurality of sectors separated from each other by a combination of straight grooves and curved grooves;

FIG. 4 shows a partial sectional view and a front view of the shroud of a preferred embodiment of the impeller according to the present disclosure. The surface of the shroud comprise a plurality of sectors separated from each other by a combination of straight grooves;

FIG. 5 shows a partial sectional view and a front view of the shroud of a preferred embodiment of the impeller according to the present disclosure. The surface of the shroud comprise a plurality of sectors separated from each other by a combination of curved grooves;

FIG. 6 shows a partial sectional view and a front view of the shroud of a preferred embodiment of the impeller according to the present disclosure. The surface of the shroud comprise a plurality of sectors separated from each other by a combination of straight grooves;

FIG. 7 shows a partial sectional view and a front view of the shroud of a preferred embodiment of the impeller according to the present disclosure. The surface of the shroud comprise a plurality of sectors separated from each other by a combination of straight grooves and curved grooves;

FIG. 8 shows a partial sectional view and a front view of the shroud of a preferred embodiment of the impeller according to the present disclosure. The surface of the shroud comprise a plurality of sectors separated from each other by a pair of circular grooves;

FIG. 9 shows a partial sectional view and a front view of the shroud of a preferred embodiment of the impeller according to the present disclosure. The surface of the shroud comprise a plurality of sectors separated from each other by a pair of quasi-elliptical grooves;

FIG. 10 shows a partial sectional view and a front view of the shroud of a preferred embodiment of the impeller according to the present disclosure. The surface of the shroud comprise a plurality of sectors separated from each other by a plurality of quasi-elliptical grooves; and

FIG. 11 shows a partial sectional view and a front view of the shroud of a preferred embodiment of the impeller according to the present disclosure. The surface of the shroud comprise a plurality of sectors separated from each other by a combination of a pair of circular grooves and a plurality of curved grooves.

The following description of exemplary embodiments refer to the accompanying drawings. The same reference numbers in different drawings identify the same or similar elements. The following detailed description does not limit the invention. Instead, the scope of the invention is defined by the appended claims.

### DESCRIPTION

Certain exemplary embodiments will now be described to provide an overall understanding of the principles of the structure, function, manufacture, and use of the devices, systems, and methods disclosed herein.

Centrifugal compressors are a class of turbo machines-or turbo rotating machines-adapted to accelerate the particles of an input compressible fluid, e.g., a gas, through the use of mechanical energy to increase the pressure thereof. Centrifugal compressors exploit centrifugal acceleration to accelerate the input gas particles, e.g., by rotating a centrifugal impeller through which the gas is forced to flow.

Centrifugal compressors may employ closed or open impellers, that is impellers manufactured with or without a shroud. Shrouded impellers guarantee higher efficiency but have a lower maximum allowable peripheral speed and, consequently, a lower maximum head to provide to the processed fluid. These limitations are due to the fact that the outer periphery of the impeller can be deformed as a result of the mechanical stress due to the centrifugal forces developing in operation because of the impeller high rotational speed. In shrouded impellers the impact of this deformation and mechanical stress is higher because the shroud is a plate which is attached to the blades and, due to centrifugal forces, is subject to large displacements that can end up damaging both the shroud and the blades if the rotational speed gets too high.

Embodiments described herein refer to a shrouded impeller and to a method to build multi-material shrouded impellers suitable to rotate with peripheral speed higher than the one reachable with single material shrouded impellers. The method comprises depositing, on the shroud of a pre-machined impeller base material, additional material by cold spray additive manufacturing. The material deposited by cold spray additive manufacturing may comprise single or multiple layers, each one with a specific shape and/or material and/or characteristic.

One embodiment of the impeller 10 according to the present disclosure comprises a hub 11, adapted to host a driving shaft that provides the power to be transmitted to the process fluid, and a shroud 12. A plurality of blades 13 are interposed between the hub 11 and the shroud 12. Vanes develop outwardly from the hub 11 and are shaped in such a way to displace the working fluid from a low-pressure side inlet—the impeller eye, placed on the shroud in a frontal area of the impeller 10—to a high-pressure side outlet located at the periphery of the impeller 10.

During operation, the working fluid enters in the vanes between the blades 13, from the impeller eye, along a direction substantially parallel to an axis of rotation of the impeller 10 and exits, energized by the action of the impeller 10, from the outlet defined by a peripheral circumferential edge of the impeller 10.

The shroud 12 is subject to centrifugal acceleration and forces that cause larger displacements with respect to the hub 11. Being the blades 13 attached to both the shroud 12 and the hub 11 they are subject to much higher stress with respect to unshrouded impellers, and can incur in major damages, if the impeller peripheral speed is not properly limited. The centrifugal forces applied by the shroud 12 to the blades are proportional to the mass of the shroud that, for a given geometry, is proportional to its density.

Typically, closed impellers designed to run at very high peripheral speed are made by a single material, for instance a special steel with high yield stress or a low-density material (e.g. titanium or aluminum alloy).

Closed impellers made by steel compensate the centrifugal forces generated by the high-density shroud (about 7850 kg/m3 ), with blades made by the same material that have high yield stress.

Closed impellers made by low-density materials compensate the lower resistance of the blades with lower forces generated by the reduced density (about 4500 kg/m3 for titanium and 2700 kg/m3 for aluminum) of the shroud.

According to the present disclosure the impeller can be manufactured with one or more metallic materials that can be deposited by cold spray additive manufacturing over a metallic base.

Cold spraying is a coating deposition method wherein solid powders (generally in the range 1 to 50 micrometers in diameter) are accelerated in a supersonic gas jet to a speed up to 500-1000 m/s. Metals, polymers, ceramics, composite materials and nanocrystalline powders can be deposited using cold spraying. During impact with the substrate, particles undergo plastic deformation and adhere to the treated surface. The kinetic energy of the powder particles, supplied by the expansion of the gas in the supersonic gas jet, is converted to plastic deformation energy during bonding. Unlike thermal spraying techniques, e.g., plasma spraying, arc spraying, flame spraying, or high velocity oxygen fuel, the powders are not melted during the cold spraying process.

The applicant found that applying cold spraying technology to the field of manufacturing impellers, in particular impellers for centrifugal compressors, allows having a minimal impact on the impeller since no metal melting is required.

Being cold spraying additive manufacturing a cold process, the initial physical and chemical properties of the particles of the employed materials are retained and the heating of the substrate is minimal, resulting in cold-worked microstructure of coatings where no macroscopic phenomena of melting and solidification take place, thus avoiding any possible weakening of the metal structure of the impeller.

The shroud 12 of the impeller 10 according to the disclosure may comprise a single deposited layer or multiple layers. When a structure provided with a deposited single layer is employed, the materials that can be used are, preferably, the following: Al alloys (as AL2024, A16061, AL7050 etc) or Ti alloys (as Ti6A14V, Ti6A14V ELI, Ti Grade 17 etc.) due to low density, high mechanical properties and wide commercial availability.

In order to reduce the amount of mechanical stress that develops, in operation, between the shroud base material and the material deposited by cold spraying, mechanical stress due to the difference between the properties of the two materials in contact (for instance CTE and Young modulus), a multilayer structure can be envisaged in order to obtain a graded structure wherein the properties of the employed materials change gradually from one layer to the next.

Multilayer structures thus comprise a plurality of layers deposited on the surface of the impeller shroud 12. Preferably, the heaviest metals or alloys are deposited first in a thin layer, in order to have best adhesion to the impeller shroud 12 surface and minimize mechanical stress when in operation. In more general terms, the sequence of the employed layers is chosen in order to make sure that at least one property of the metals or alloys of said layers varies gradually from the first to the last layer deposited. Said at least one property can be, for instance, molecular weight or molar mass, density, CTE, Young modulus etc.

In case of a two-layer structure, a second layer is deposited on top of the first layer, the second layer being made of a lighter material with respect to the material of the first layer. The first, heavier layer can be made, for instance, of Fe or Ni alloys. The second, lighter, layer can be made of metals or alloys of Al, Mg, Ti and Fe when the first layer is made of Ni. Embodiments of the impeller provided with a two-layer structure and according to the disclosure may employ the following combinations of metals or alloys (first metal/alloy being referred to the first or inner layer, second metal/alloy being referred to the second or outer layer): Fe—Al; Ni—Al; Fe—Mg; Ni—Mg; Fe—Ti; Ni—Ti; Ni—Fe, In case of multi-layer structures, one embodiment comprises an intermediate third layer interposed between the above described two layers and another embodiment comprises one additional third layer placed on top of the other two layers to protect the structure from corrosion, erosion or wear due to the environment. A first, heavier layer is deposited by cold spraying on the impeller shroud, then an intermediate second layer is cold sprayed on the first layer to minimize mechanical stress between different layers. Finally, a third, lighter layer is deposited on top of the second layer.

Embodiments of three-layer shroud 12 of the impeller according to the disclosure may employ an intermediate layer made of the following metals or alloys: Al, Ti, Mg, Fe, Ni, Co, Mo, Cr. Preferred examples of three layers shrouds may employ the following sequences of metals or alloys, wherein the metal or alloy mentioned first is the first to be cold sprayed on the shroud: Ti—Al—Mg, Ni—Fe—Ti, Ni—Fe—Al, Ni—Ti—Al, Fe—Ti—Al, Co—Ni—Al. All the above examples provide a sequence of metals/alloys characterised by at least one property varying gradually from the first to the last layer deposited. In the above example Ti—Al—Mg, for instance, Ti has physical properties which are in between the steel substrate and the following layer of Al.

Further embodiments of the present disclosure employ an additional, external layer helpful to provide extra resistance against corrosion, erosion and wear. An additional, external layer can be deposited on top of the single, double or triple layer cold sprayed on the shroud surface, to strengthen the structure against aggressive environment agents. Examples of this additional, external layer may be made of the following metals or alloys: Ti, Ni, Co, Mo, and Cr.

The impellers according to the present disclosure can be manufactured according to several procedures. In one embodiment, an impeller body can be manufactured with different technologies (e.g. forged, casted, hipped or 3D printed) and in a wide choice of materials, e.g. steel, (for instance AISI410, ASTM A182 F22, 17-4PH etc.) or Ni alloy (for instance IN625M PM, IN718 etc.). The impeller body is pre-machined by processes of turning and milling, then single or multiple layers of metal or metal alloys are deposited by cold spraying on the surface of the frontal part of the impeller where the shroud will be; finally the impeller is machined to manufacture the complete structure of the impeller comprising blades and vanes. The final machining of the impeller will be adapted to suitably shape the shroud, choosing the width of the base material with respect to the width of the cold sprayed external materials optimizing the overall characteristics of the impeller to maximize the allowable peripheral speed and maximum power transmissible to the gas. In one embodiment the final machining is adapted to completely remove the base layer of original steel of the shroud in order to leave only the cold spray deposited layers.

In another embodiment the impeller base material is pre-machined and then it is further machined to manufacture the complete structure of the impeller comprising blades and vanes. Finally the shroud of the impeller is cold sprayed to add one or more layers of metal or metal alloys.

In a further embodiment the impeller base material is pre-machined by processes of turning and milling to manufacture the structure of the impeller comprising blades and vanes. Then the shroud of the impeller is cold sprayed to add one or more layers of metal or metal alloys.

The use of cold spraying techniques allows a degree of flexibility that can be exploited to further optimize the dynamic behavior of the impeller. Thus, the deposition of the additional metal or metal alloy layers on the external surface of the shroud can be made even and uniform and also according to more complex, preferred patterns and lay-outs.

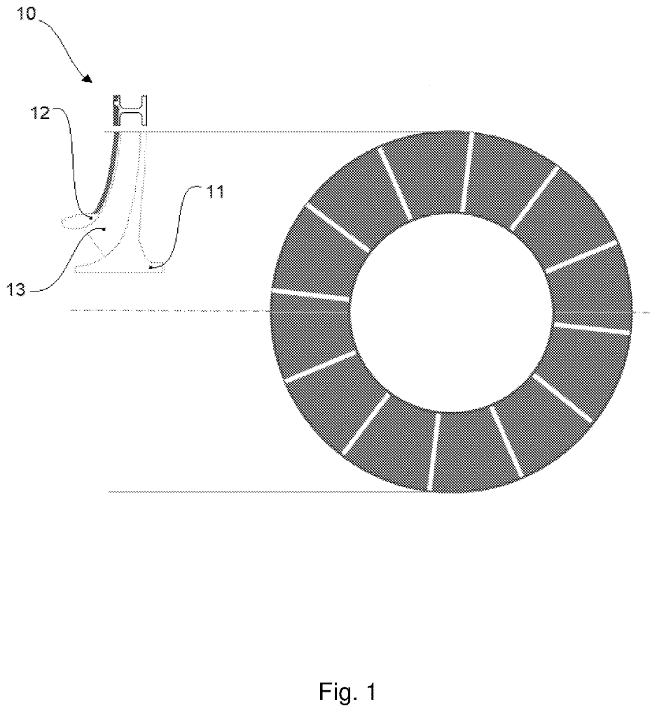

With reference to FIG. 1, showing a partial sectional view of the impeller and a front view of the shroud of the impeller, one or more of the additional cold sprayed layers is not even but it is made of a plurality of sectors, separated from the adjacent ones by a plurality of grooves 14 where no additional material has been deposited or where the deposited material has a thinner width. The radial grooves originate from the inner edge of the shroud, run to the outer edge of the shroud and are approximately centered in the center of the eye of the impeller. The number of grooves can be chosen based on the impeller requirements (number of blades, peripheral speed, exciting frequencies etc.). Moreover, the number and the shape of the grooves can be useful to tune the local natural resonance frequencies thus allowing the designer to clear said natural resonance frequencies from the exciting frequencies that are potentially very harmful to the impeller. Furthermore, the number and the shape of the grooves can be suitably chosen for reducing the stress on the deposited layers.

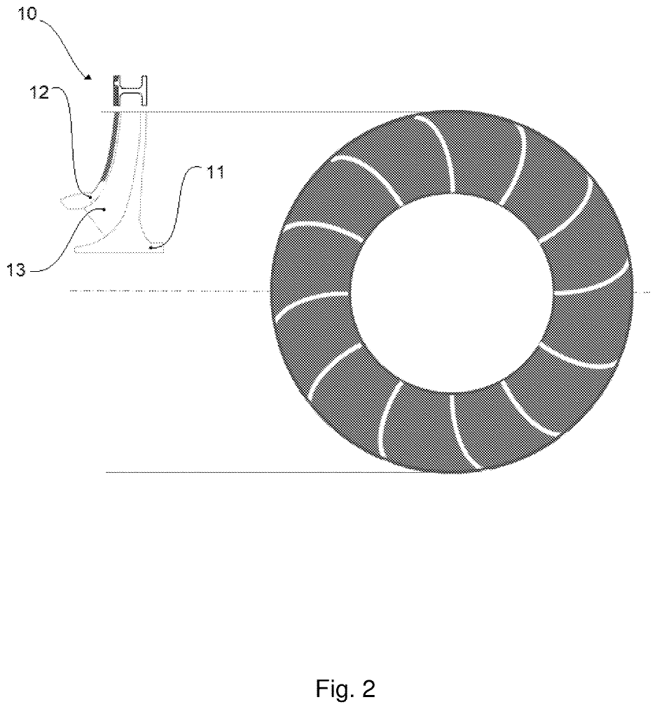

With reference to FIG. 2, showing another embodiment, the grooves are still substantially radial but curved.

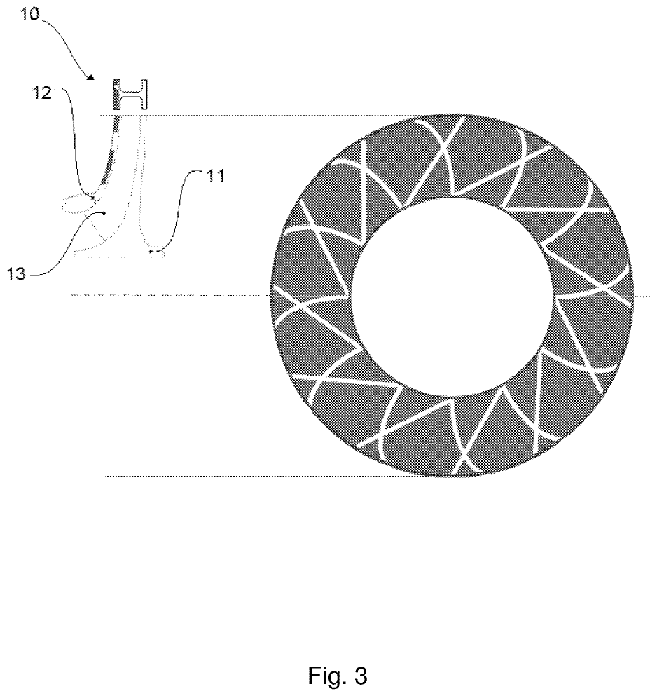

FIG. 3 shows another embodiment wherein a plurality of couples of grooves, one curved and one straight, originates from the inner edge of the shroud in an approximately radial fashion and run to the outer edge of the shroud. The straight groove of each couple intersect with the curved groove of the following couple.

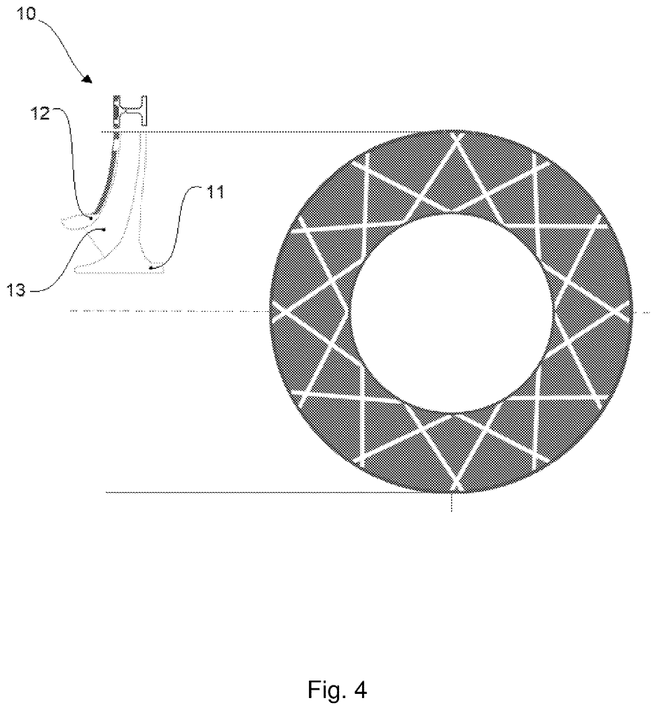

FIG. 4 shows one more embodiment wherein a plurality of couples of straight grooves originates from the inner edge of the shroud in an approximately radial fashion and run to the outer edge of the shroud. Each groove of each couple of grooves intersects with one groove of two following or two previous couples of grooves.

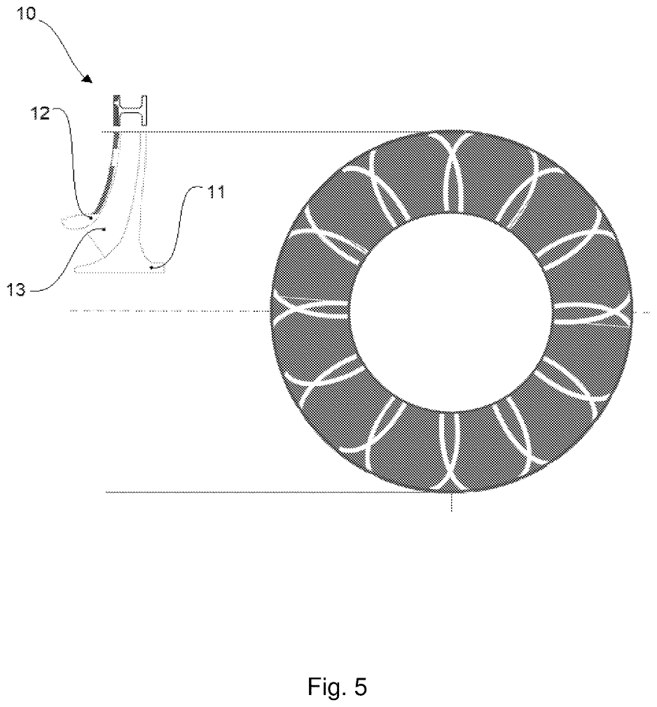

FIG. 5 shows another embodiment wherein a plurality of couples of curved grooves originates from the inner edge of the shroud in an approximately radial fashion and run to the outer edge of the shroud. The curved grooves of each couple intersect with each other and have their concavities facing each other.

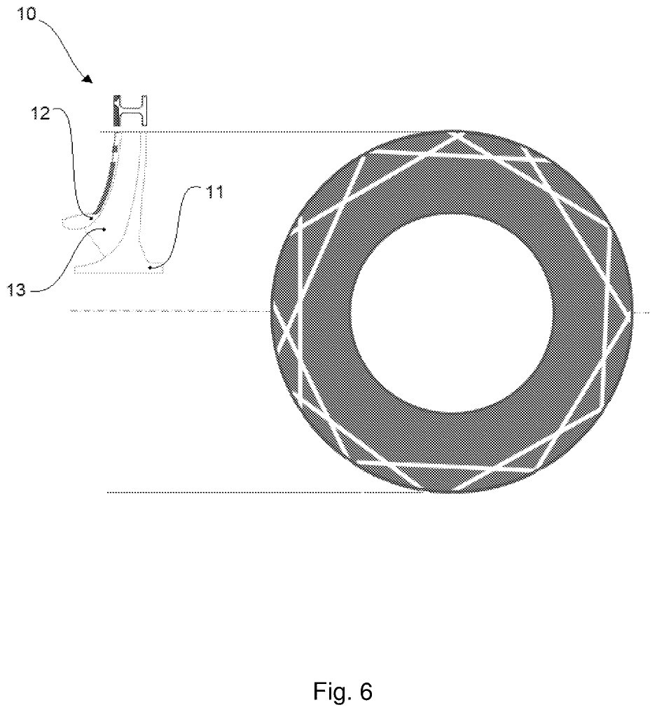

FIG. 6 shows another embodiment wherein a plurality of straight grooves are arranged like chords of the approximately circular outer edge of the shroud of the impeller. Each groove intersects with at least two other grooves.

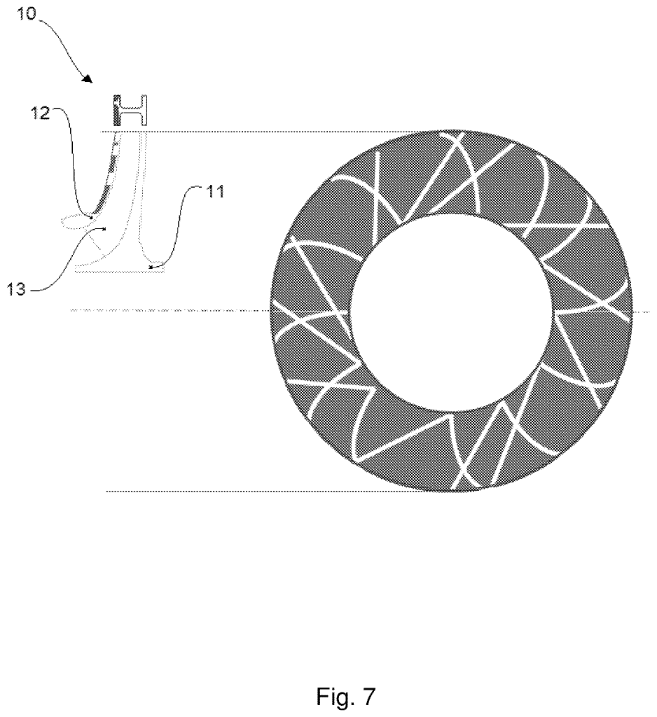

FIG. 7 shows another embodiment wherein a plurality of curved and straight grooves originates from the inner edge of the shroud in an approximately radial fashion and run to the outer edge of the shroud. Each straight groove intersects with at least one adjacent curved groove.

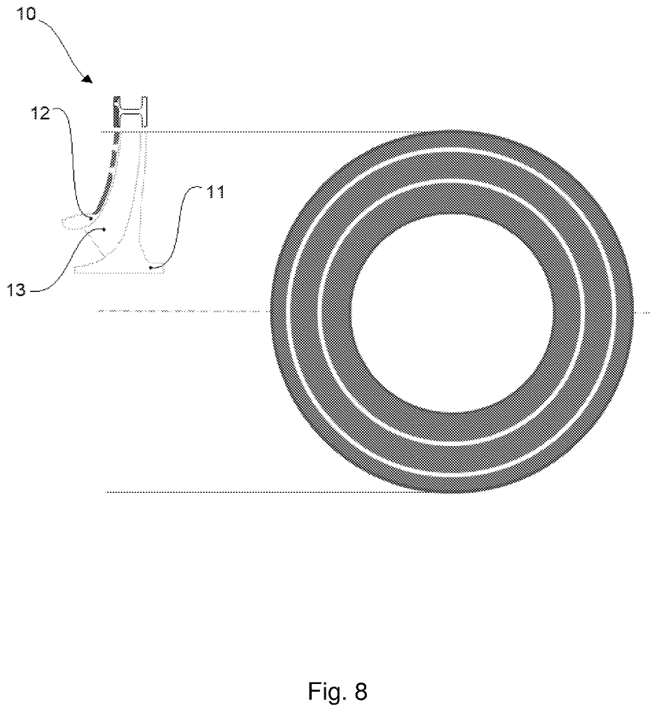

FIG. 8 shows another embodiment wherein two circular grooves divides the surface of the shroud into three circular crowns.

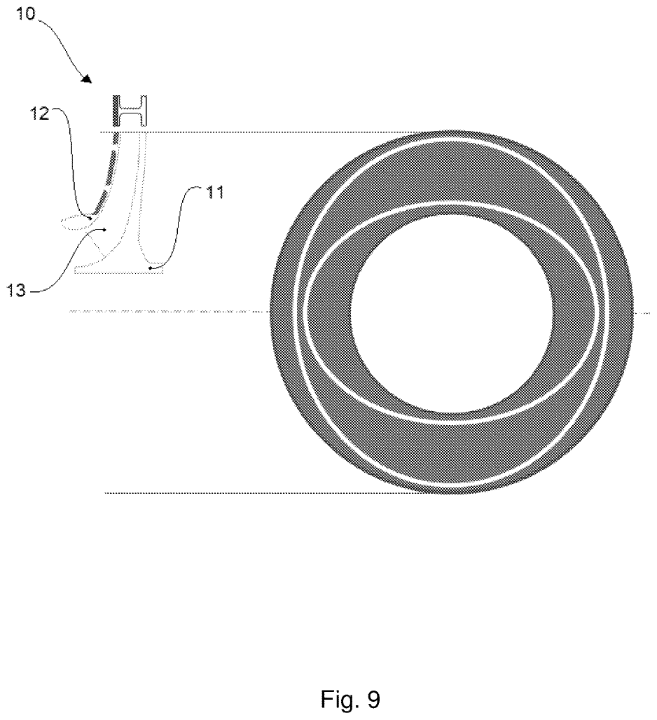

FIG. 9 shows another embodiment wherein two quasi-elliptical grooves divides the surface of the shroud into three sections.

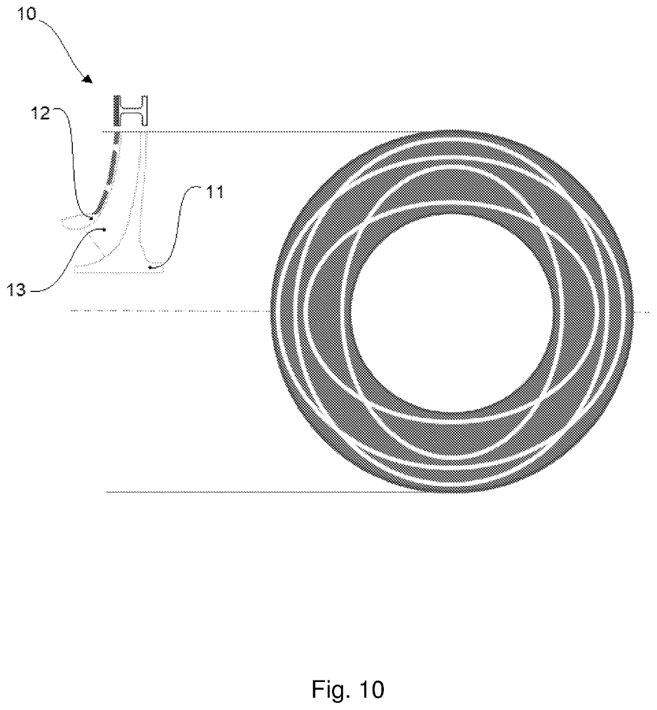

FIG. 10 shows another embodiment wherein a plurality of quasi-elliptical grooves divides the surface of the shroud into a plurality of sections.

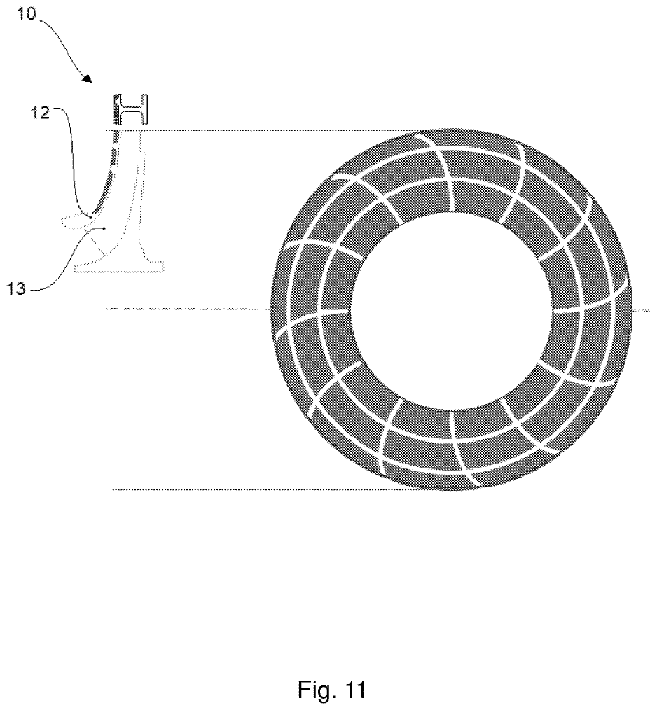

FIG. 11 shows another embodiment wherein a plurality of couples of curved grooves originates from the inner edge of the shroud in an approximately radial fashion, run to the outer edge of the shroud and intersect with two circular grooves to divide the surface of the shroud into a plurality of sections.

All the previously described embodiments are aimed at optimizing the dynamic behavior of the impeller by modifying and tuning the local natural frequencies in order to avoid dangerous crossings between natural and exciting frequencies that can be harmful to the integrity of the impeller when in operation.

What is claimed is:

1. An impeller, comprising:
a hub;
blades attached to the hub;
a shroud attached to the blades; and
layers of material deposited on the shroud, each of the layers deposited by cold spraying, the layers of material comprise a layer discontinuously deposited to define circumferentially distributed sectors such that the sectors are separated by continuous grooves extending through the layer thickness and defining discrete regions of deposited material,
wherein the sectors and the grooves are in an arrangement to modify local dynamic properties of the shroud.

2. The impeller of claim 1, wherein the layers of material form a load bearing portion of the shroud.

3. The impeller of claim 1, wherein the grooves are in a number that is proportional to the number of blades.

4. The impeller of claim 1, wherein the grooves are formed by selectively withholding deposition during cold spraying.

5. The impeller of claim 1, wherein the arrangement shifts at least one natural frequency of the shroud away from an excitation frequency for the shroud.

6. The impeller of claim 1, wherein the layers comprise layers of different materials.

7. The impeller of claim 1, wherein sectors of an outer layer of a first material overlay sectors of an inner layer of a second material that is different from the first material.

8. The impeller of claim 1, wherein the grooves comprise a first groove and a second groove that intersect with one another.

9. A centrifugal compressor, comprising:
a closed impeller comprising a multi-layer structure built up on a surface, each layer of the multi-layer structure deposited by cold spraying,
wherein at least one layer is discontinuously deposited to define circumferentially distributed sectors separated by continuous grooves extending through the layer thickness and defining discrete regions of deposited material.

10. The centrifugal compressor of claim 9, wherein the grooves form an arrangement that modifies local dynamic properties of the closed impeller.

11. The centrifugal compressor of claim 9, wherein the grooves are in a number that is proportional to the number of blades.

12. The centrifugal compressor of claim 9, wherein the grooves comprise a first groove and a second groove that intersect with one another.

13. The centrifugal compressor of claim 9, wherein the grooves reside in an outer layer of the multi-layer structure.

14. The centrifugal compressor of claim 9, wherein the multi-layer structure comprises layers made from a single metal alloy.

15. The centrifugal compressor of claim 9, wherein the multi-layer structure comprises layers made from different metal alloys.

16. The centrifugal compressor of claim 9, wherein the multi-layer structure comprises layers made from materials that change layer-by-layer.

17. The centrifugal compressor of claim 9, wherein the multi-layer structure comprises layers with different Youngs modulus.

18. The centrifugal compressor of claim 9, wherein the multi-layer structure comprises layers with different CTE.

19. A method, comprising:
cold-spraying material onto a surface of a closed impeller to form a multi-layer structure on the surface;
selectively interrupting deposition during cold spraying to define circumferentially distributed sectors separated by grooves corresponding to regions of no material deposition,
wherein the grooves are in a pattern based on predicted excitation frequency of the closed impeller.

20. The method of claim 19, further comprising:
installing the closed impeller in a centrifugal compressor.
